(19) United States
(12) Patent Application Publication
(10) Pub. No.: US 2009/0134791 A1
(43) Pub. Date: May 28, 2009

(54) EL light-emitting sheet and EL light-emitting device

(75) Inventor: Mutsumi Kubota, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: RISO KAGAKU CORPORATION, Tokyo (JP)

(21) Appl. No.: 12/289,361

(22) Filed: Oct. 27, 2008

(30) Foreign Application Priority Data
Nov. 27, 2007 (JP) 2007-305942

(51) Int. Cl. H01J 1/62

(52) U.S. Cl. 313/506

(57) ABSTRACT

An EL light-emitting sheet is a sheet body formed by sealing a sheet-shaped EL light-emitting element with a substrate, a back electrode, an insulating layer, a light-emitting layer, and a transparent electrode stacked in this order, wherein an adhesive layer is formed in an outer side of the transparent electrode. If it is stuck by the adhesive layer at a desired position of the back of a sheet-shaped exhibit having a light-transmitting capability at least partially, when the EL light-emitting sheet does not light, only a design of a surface of the exhibit appears (FIG. 3A). When voltage is applied to the EL light-emitting sheet, a light-emitting pattern of the EL light-emitting sheet emerges from the back of the exhibit through the exhibit (FIG. 3B). Therefore, a novel effect is obtained.

### BACKGROUND OF THE INVENTION

1. Field of the Invention

The present invention relates to an EL light-emitting sheet that can obtain a high visual effect when stuck to the back of a sheet-shaped exhibit to cause light emission, an EL light-emitting sheet that can receive power supply while being nipped and held in a terminal portion, and an EL light-emitting device that can feed power while nipping and holding the EL light-emitting sheet.

2. Description of Related Art

Since an electroluminescence light-emitting element (hereinafter referred to as an EL light-emitting element) can be placed in a narrow space because it can be constructed in a thin sheet shape, it is considered useful as an advertisement medium and other display means. However, since the sheet-shaped EL element is thin and has not a self-standing capability, a display device is required to exhibit it in a specific state and feed power to it for display.

Utility Model Registration No. 3131658 described below discloses an EL light-emitting device that can easily exhibit a sheet-shaped EL element not having the self-standing capability at a desired position, and at the same time can easily feed power for display. In the EL light-emitting device, an upper cover is connected to a main body by a hinge like a clip so that it can be opened and closed, and is energized in a closing direction by a spring. An output terminal of the upper surface of the main body is connected to internal power supply and a driving circuit. If an electrode part of a sheet-shaped EL light-emitting element is nipped and closed in clearance between the main body and the upper cover, the sheet-shaped EL light-emitting element is held, and the output terminal and the electrode are brought into contact for conduction. If the main body is attached at a desired position by removable fixing means, and a power switch is turned on, the sheet-shaped EL light-emitting element can be exhibited at the desired position for light emission and display.

However, the EL light-emitting device described in Utility Model Registration No. 3131658 exhibits only an EL element, and since there are many types of self-standing display elements besides EL except the characteristic of the thin sheet shape, display effects of the EL element being a self-standing element are not so novel, so that its visual effects when used for advertisements are not sufficient.

Although the EL light-emitting device described in Utility Model Registration No. 3131658 is of clip type that nips and holds the sheet-shaped EL element described previously, and can hold a single sheet for exhibit, it is impossible to take a catalog-like exhibit mode in which numerous sheet-shaped EL elements and non-light emitting sheets are stacked and nipped, and the sheet-shaped EL elements are caused to emit light.

The present invention solves the above-described problems and provides EL light-emitting sheets and an EL light-emitting device that can exhibit sheet-shaped EL elements not having a self-standing capability by themselves not only by spontaneous light but also with a high visual effect, and furthermore can take a special exhibit mode like a catalog in which when numerous sheet-shaped EL elements and non-light emitting sheets are stacked and nipped, the sheet-shaped EL elements are caused to emit light.

### SUMMARY OF THE INVENTION

The EL light-emitting sheet described in Claim 1 is formed by sealing a sheet-shaped EL light-emitting element with a substrate, a back electrode, an insulating layer, a light-emitting layer, and a transparent electrode stacked in this order, wherein an adhesive layer is formed in an outer side of the transparent electrode, and the EL light-emitting sheet can be stuck by the adhesive layer at a desired position of the back of a sheet-shaped exhibit having a light-transmitting capability at least partially.

The EL light-emitting sheet described in Claim 1 is characterized in that, in the EL light-emitting sheet described in Claim 1, an opening is formed in the adhesive layer along a light-emitting pattern of the transparent electrode.

The EL light-emitting sheet described in Claim 3 is formed by sealing a sheet-shaped EL light-emitting element with a substrate, a back electrode, an insulating layer, a light-emitting layer, and a transparent electrode stacked in this order, wherein a through-hole is formed in the EL light-emitting sheet, and the electrode of the EL light-emitting element is electrically connected through the through-hole to an input terminal provided at each of corresponding positions of both sides of the EL light-emitting sheet.

The EL light-emitting device described in Claim 4 holds and drives an EL light-emitting sheet formed by sealing a sheet-shaped EL light-emitting element with a substrate, a back electrode, an insulating layer, a light-emitting layer, and a transparent electrode stacked in this order in which a through-hole is formed, and the electrode of the EL light-emitting element is electrically connected through the through-hole to an input terminal provided at each of corresponding positions of both sides of the EL light-emitting sheet, wherein the EL light-emitting device includes a driving circuit, an output terminal connected to the driving circuit, and releasable fixing means for pressing and fixing the EL light-emitting sheet stacked on the output terminal to bring the input terminal of the EL light-emitting sheet into contact with the output terminal.

The EL light-emitting device described in Claim 5 is characterized in that, in the EL light-emitting device described in Claim 4, a through-hole is formed in a sheet body, and a non-light emitting sheet formed by electrically connecting electrodes provided respectively at corresponding positions of both sides of the sheet body through the through-hole is stacked on the EL light-emitting sheet and fixed by the fixing means to bring the electrode of the non-light emitting sheet, the input terminal of the EL light-emitting sheet, and the output terminal into electrical connection.

According to the EL light-emitting sheet described in Claim 1, if an adhesive layer outside a transparent electrode from which display light is emitted is bonded at a desired position of the back of a sheet-shaped exhibit, the EL light-emitting sheet can be stuck at a desired position of the back of the exhibit. When the exhibit is observed from the front, a light-emitting pattern is not viewed when the EL light-emitting sheet does not light, only a design on the front of the exhibit is viewed. However, when the EL light-emitting sheet lights, the light-emitting pattern of the EL light-emitting sheet emerges from the back of the exhibit, and can be viewed from the front through the exhibit. Since the display pattern is observed in overlap or in line with a design on the front of the exhibit, a high visual effect is obtained.

According to the EL light-emitting sheet described in Claim 2, in the effect of the EL light-emitting sheet described in Claim 1, since an opening is formed in the adhesive layer along the light emitting pattern of the transparent electrode, the adhesive layer prevents reduction in the brightness of the light-emitting layer.

According to the EL light-emitting sheet described in Claim 3, since input terminals are provided at corresponding positions on both sides of the EL light-emitting sheet, if plural EL light-emitting sheets are stacked so as to bring the input terminals into contact, electrodes of all EL light-emitting sheets are electrically connected, and the EL light-emitting sheets can be driven by affording a driving signal by a single EL light-emitting device.

According to the EL light-emitting sheet described in Claim 4, plural the EL light-emitting sheet as described in Claim 3 are provided, their input terminals are stacked so that they contact vertically with each other, and an input terminal of the lowest EL light-emitting sheet is brought into contact with an output terminal of the EL light-emitting device, and the plural EL light-emitting sheets are fixed by fixing means. By this arrangement, the plural EL light-emitting sheets electrically connected to each other can be driven for light emission by the driving circuit, and light-emitted and exhibited in catalog-shaped or note-shaped mode. The EL light-emitting sheets can be easily replaced by releasing the fixing means.

According to the EL light-emitting device described in Claim 5, in the effect of the EL light-emitting device described in Claim 4, the EL light-emitting sheets that are light-emitted and displayed may be stacked for integration.

### BRIEF DESCRIPTION OF THE DRAWINGS

FIG. 1 is an exploded enlarged perspective view of an EL light-emitting sheet of a first embodiment;

FIGS. 2A and 2B are drawings showing how to use an EL light-emitting sheet of the first embodiment;

FIGS. 3A and 3B are drawings showing states in which an EL light-emitting sheet of the first embodiment is used;

FIG. 4 is a perspective view showing a variant of an adhesive layer in an EL light-emitting sheet of the first embodiment;

FIG. 5 is a perspective view of an EL light-emitting device of a second embodiment;

FIG. 6 is a perspective drawing showing how to use an EL light-emitting device of the second embodiment;

FIGS. 7A and 7B are drawings showing an EL light-emitting sheet and a non-light emission used in an EL light-emitting device of the second embodiment;

FIG. 8 is a sectional view of an EL light-emitting device of the second embodiment; and

FIG. 9 is a partially enlarged drawing of A of FIG. 8.

### DETAILED DESCRIPTION OF THE PREFERRED EMBODIMENTS

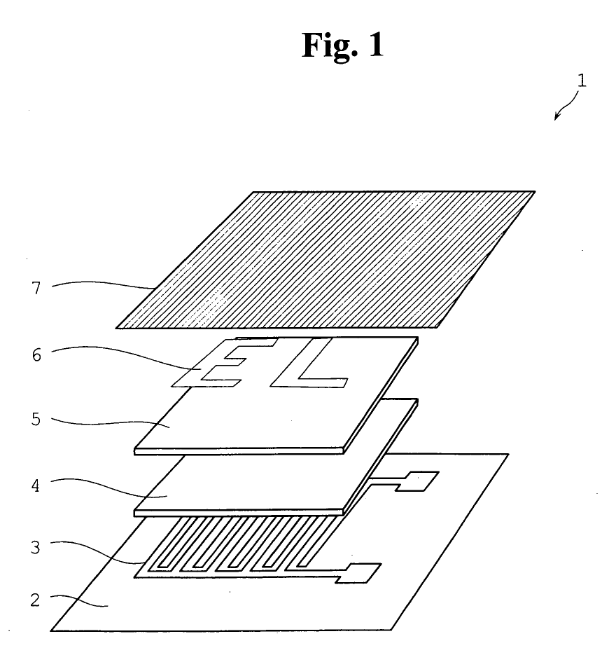

Hereinafter, the embodiments of the present invention considered best at the time of filing by the applicant to implement the present invention will be described with reference to FIGS. 1 to 9.

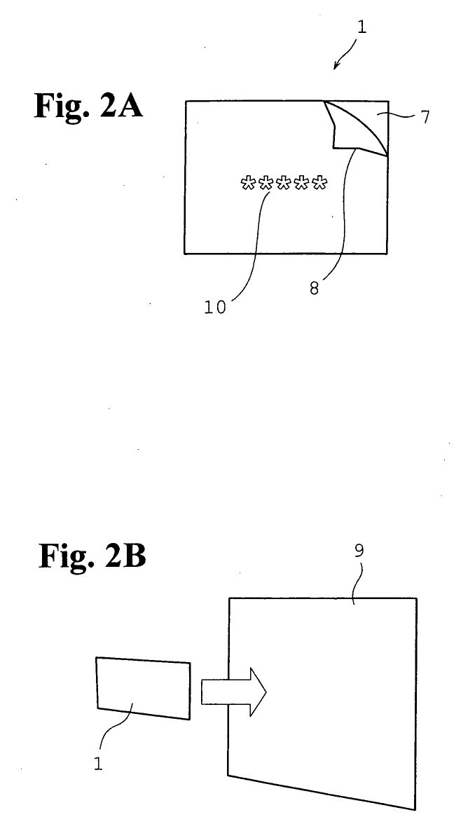

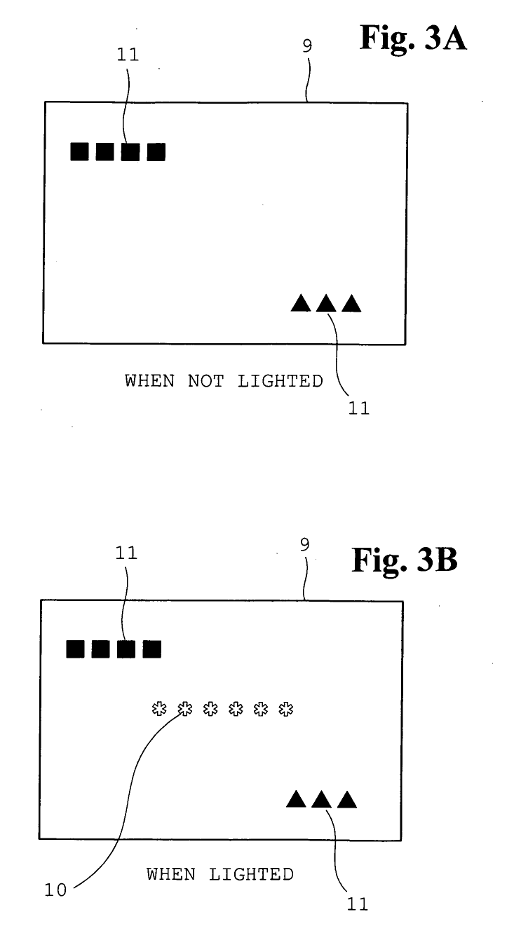

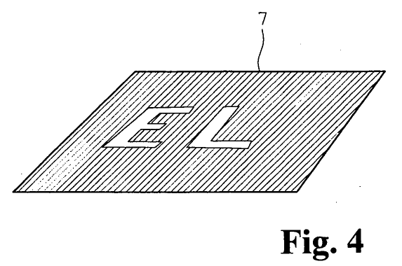

FIGS. 1 to 4 are drawings of a first embodiment, wherein FIG. 1 is an exploded enlarged perspective view of an EL light-emitting sheet of the first embodiment, FIGS. 2A and 2B are drawings showing how to use an EL light-emitting sheet of the first embodiment, FIGS. 3A and 3B are drawings showing states in which an EL light-emitting sheet of the first embodiment is used, and FIG. 4 is a perspective view showing a variant of an adhesive layer in an EL light-emitting sheet of the first embodiment.

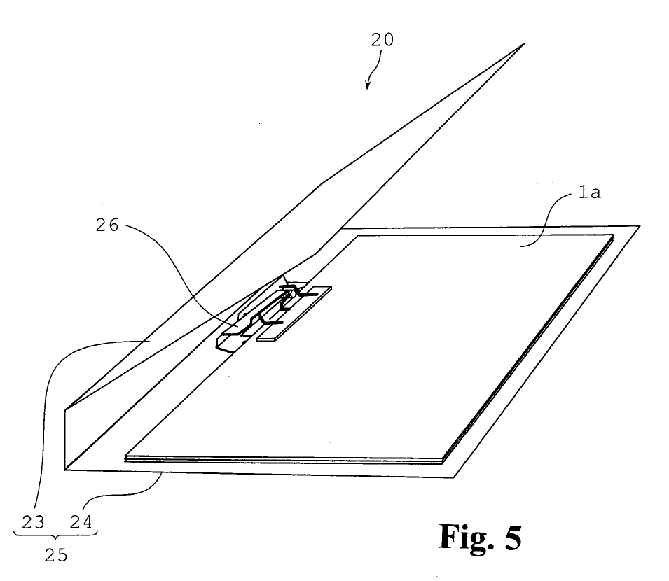

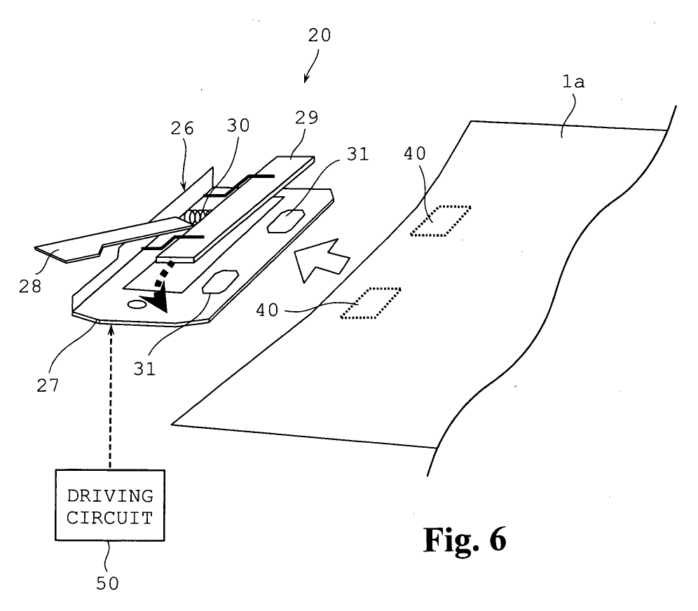

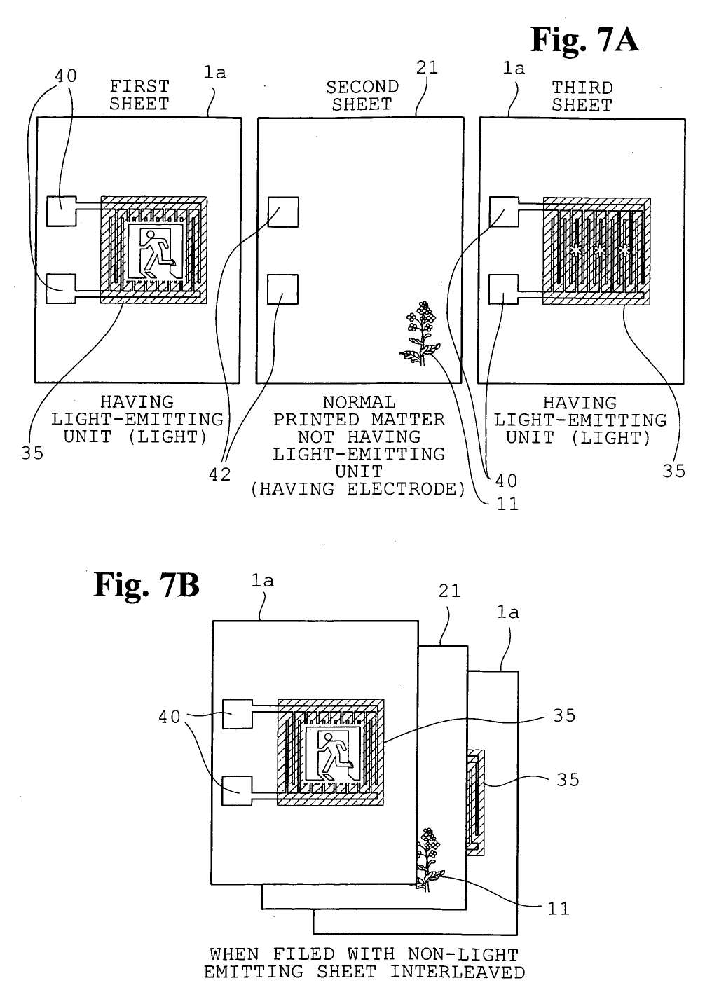

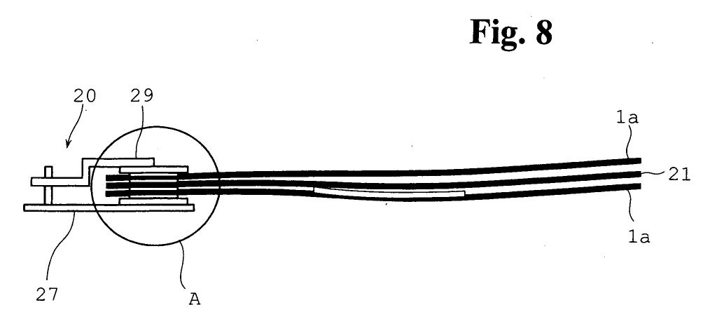

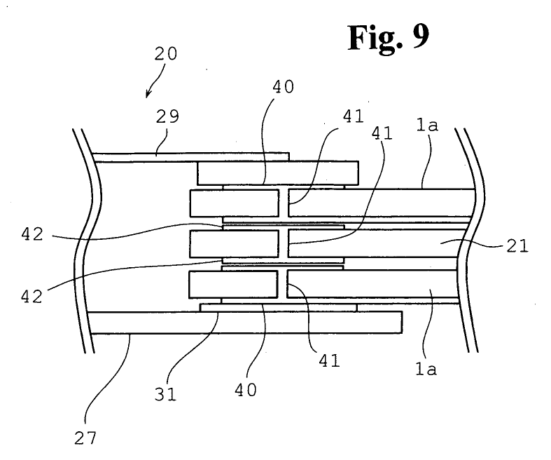

FIGS. 5 to 9 are drawings of a second embodiment, wherein FIG. 5 is a perspective view of an EL light-emitting device of the second embodiment, FIG. 6 is a perspective drawing showing how to use an EL light-emitting device of the second embodiment, FIGS. 7A and 7B are drawings showing an EL light-emitting sheet and a non-light emission used in an EL light-emitting device of the second embodiment, FIG. 8 is a sectional view of an EL light-emitting device of the second embodiment, and FIG. 9 is a partially enlarged drawing of A of FIG. 8.

### 1. First Embodiment

### First Example, FIGS. 1 to 4

The following describes the construction of an EL light-emitting sheet of a first embodiment.

As shown in FIG. 1, an EL light-emitting sheet 1 of this example has a sheet-shaped EL light-emitting element of a multilayer structure including: a sheet-shaped substrate 2 made of an insulating material; a back electrode 3 formed on the substrate 2; an insulating layer 4 provided on the back electrode 3; a light-emitting layer 5 formed in a desired light-emitting pattern provided on the insulating layer 4; and a transparent electrode 6 provided on a light-emitting layer 5. Since the substrate 2 itself is an insulation, a resist layer does not need to be provided below the back electrode 3. The sheet-shaped EL light-emitting element is sealed in airtight state by a sheet-shaped sealing member (not shown in the drawing) having a light-transmitting capability, and furthermore an adhesive layer 7 is formed on the surface of the sealing member at the outer side of the transparent electrode 6. When the EL light-emitting sheet is not used, the adhesive layer 7 is covered with a release coated paper 8 as protection means.

When the EL light-emitting sheet 1 is used, as shown in FIG. 2A, the release coated paper 8 is stripped from the adhesive layer 7, and as shown in FIG. 2B, the EL light-emitting sheet 1 is stuck by the adhesive layer 7 at a desired position of the back of a sheet-shaped exhibit 9 (e.g., poster) having a light-transmitting capability at least partially. A driving device (not shown in the drawing) is connected to each electrode of the EL light-emitting sheet 1, and if the light-emitting layer is driven into light emission by the driving devices, a light-emitting pattern 10 of the light-emitting layer and a display content of the exhibit 9 are integrated for display and exhibit.

The sheet-shaped exhibit 9 to which the EL light-emitting sheet 1 is to be stuck is a material having light shielding properties and light transmitting properties. Although a material such as paper is preferably cited, the present invention is not limited to this. If the exhibit 9 has such properties, a novel effect as described below can be obtained. Specifically, as shown in FIG. 3A, only a design 11 of the surface of the exhibit 9 (a ground color of the surface of the exhibit 9 if it is plain) appears when the EL light-emitting sheet 1 does not emit light, and the light-emitting pattern 10 of the EL light-emitting sheet 1 is shielded. When voltage is applied to the EL light-emitting sheet 1 by the driving devices, as shown in FIG. 3B, the light-emitting pattern 10 of the EL light-emitting sheet 1 emerges through the exhibit from the back of the exhibit 9.

For example, when a poster or the like as described previously is selected as the exhibit 9 to which the EL light-emitting sheet 1 is to be stuck, and the EL light-emitting sheet 1 is stuck to the back of it, since the light-emitting pattern 10 emerges from the back of traditional printed matter, a notice having a high visual effect can be easily obtained.

As shown in FIG. 4, if an opening is formed in the adhesive layer 7 by cutting out a portion corresponding to the portion of the light-emitting pattern 10 corresponding to the transparent electrode 6 of the light-emitting layer 5 in the same shape as the light-emitting pattern 10, brightness reduction caused when light from the light-emitting layer 5 of the EL light-emitting sheet 1 passes through the adhesive layer 7 can be reduced.

Furthermore, by adjusting the thickness of the adhesive layer 7, the gap between the light-emitting layer 5 and the exhibit 9 to be stuck to can be adjusted to obtain more effects. Specifically, by bringing the EL light-emitting sheet 1 and the exhibit 9 into close contact, the light-emitting pattern 10 can be made to emerge with high brightness and clear. By widening the gap, brightness decreases, but the effect of diffused light emission can be obtained. In this case, the gap between the light-emitting layer 5 and the exhibit 9 may be adjusted not only by adjusting the thickness of the adhesive layer 7 itself but also by putting some sheet-shaped material of proper thickness between both.

As has been described above, according to the EL light-emitting sheet 1 of the present invention, the following effects can be obtained.

Since the light-emitting pattern 10 of the EL light-emitting sheet 1 emerges at any timing from the back of the exhibit 9 such as poster, a high visual effect can be obtained. At this time, by using printed matter of the design 11 on the surface of the exhibit 9, a multiplier effect of a visual effect by printed information and light can be obtained.

By using paper for the exhibit 9, a desired design 11 can be easily printed in desired colors. Therefore, the design 11 having a high degree of freedom of printed matter, and a display (light-emitting pattern 11) such as a concealed message and a display for security that are not usually displayed but need to be displayed clear by spontaneous light emission in a specific condition can be overlapped for display only when necessary, providing a high display effect and giving high additional values to normal printed matter.

As the exhibit 9 to be stuck to, if some permeability of light exists, materials are not limited, and a wide range of materials such as paper and film can be used.

Furthermore, if the exhibit 9 to be stuck to has some degree of concealability, since the light-emitting pattern 10 can be concealed during non-light emission, more novel effects are obtained.

Thus, by sticking the EL light-emitting sheet to the exhibit 9 as an assembly, light-emitting positions in the exhibit 9 can be freely specified by the user. Although a possible method is to directly fabricate an EL light-emitting element in the sheet-shaped exhibit 9, in comparison with this method, according to this example, there are effects that cumbersomeness in EL fabrication process, the danger of organic solvents and the like, and bad yields are eliminated.

### 2. Second Embodiment

### Second Example, FIGS. 5 to 9

The following describes the construction of an EL light-emitting sheet 1a of a second embodiment, and an EL light-emitting device 20 that holds and lights it.

In this example, plural EL light-emitting sheets 1a are filed in a binder-shaped EL light-emitting device 20 for power feed and light emission. Furthermore, a non-light emitting sheet 21 having no light-emitting unit can be put in the plural EL light-emitting sheets 1a, in which case the EL light-emitting sheets 1a and the non-light emitting sheet 21 have, in the surface and back of them, input terminals as a common electrode structure that are electrically connected to each other with a through-hole-shaped structure, so that power can be fed to all the stacked sheets.

As shown in FIG. 5, the EL light-emitting device 20 of this example includes a file 25 in which the front cover and the rear cover are integrated to be freely opened and closed, and fixing means 26 attached at the center of the back side of the rear cover 24 within the file 25. As shown in FIG. 6, the fixing means includes: a substrate 27 fixed to the file 25; a lever 28 provided in the substrate 27 that is freely rotated; a holding plate 29 that moves in a slant direction on the substrate 27 in linkage with the lever 28; and a spring 30 interposed between the lever 28 and the holding plate 29. Operating the lever 28 to lift the holding plate 29, and operating the lever 28 in the opposite direction with sheets sandwiched would lower the holding plate 29 and fix the sheets between the substrate 27 and the holding plate 29 with the elasticity of the spring 30.

As shown in FIG. 6, the substrate 27 of the fixing means 26 is provided with output terminals 31 for feeding power to the EL light-emitting sheet 1a, and the output terminals 31 are connected to a driving circuit 50. If the input terminals 40 of the EL light-emitting sheet 1a are brought into contact with the output terminals 31 of the EL light-emitting device 20 by overlaying the EL light-emitting sheet 1a on the output terminals 31 of the EL light-emitting device 20 and fixing them by the fixing means 26, power is fed to the plural EL light-emitting sheets 1a filed in the EL light-emitting device 20 for light emission and display.

The EL light-emitting sheets 1a used in this example shown laterally in FIG. 7A, like that of the first example, include a sheet-shaped EL light-emitting element with a sheet as a substrate, a back electrode, an insulating layer, a light-emitting layer, and a transparent electrode sequentially stacked, wherein at least the stacked electrode portion is sealed, and the light-emitting layer constitutes a light-emitting unit 35 of a specific pattern. The EL light-emitting sheets 1a include a light-emitting unit 35 using a comb electrode, and the input terminals 40 for feeding power. The input terminals 40 are provided on both sides at specific positions corresponding to the back side of the EL light-emitting sheets 1a filed in the EL light-emitting device 20. As shown in FIG. 8 showing a sectional view of the EL light-emitting sheets 1a when filed, or FIG. 9 showing an enlarged view of part A of FIG. 8, through-holes 41 are formed in the EL light-emitting sheets 1a, electrodes of an EL light-emitting element not shown in the drawings are electrically connected through the through-holes 41 to the input terminals 40 respectively provided at corresponding positions (just above the through-holes 41) of both sides of the EL light-emitting sheet 1a.

The non-light emitting sheet 21 shown at the center of FIG. 7A, which is a normal or normal printed matter that has the same shape as the EL light-emitting sheets 1a but has no electrode structure as EL, is printed with a desired design 11. However, in the non-light emitting sheet 21, electrodes 42 are formed with the same structure and placement as the input terminals 40 of the EL light-emitting sheet 1a. That is, the electrodes 42 of the non-light emitting sheet 21 penetrate through both sides and are electrically connected at the same positions as the input terminals 40, but are not connected to electrodes of other electronic elements.

The EL light-emitting device 20 of this example can stack and file the non-light emitting sheet 21 along with the EL light-emitting sheets 1a, as described previously. As shown in FIGS. 7B and 9, the EL light-emitting sheets 1a and the non-light emitting sheet 21 are correctly stacked, since electrical connection is made vertically between the input terminals 40 of the EL light-emitting sheets 1a and the electrodes of the non-light emitting sheet 21, fixing them by the EL light-emitting device 20 of this example allows electricity to be conducted to the output terminal 31.

The following describes the case where two EL light-emitting sheets 1a having the light-emitting unit 35 and one non-light emitting sheet 21 having no light-emitting unit 35 are stacked on top of one another for filing, as shown in FIG. 7B. Since the input terminals 40 of the EL light-emitting sheets 1a and the electrodes 42 of the non-light emitting sheet 21 both have a through-hole electrode structure in which electricity is conducted to both sides of the sheets, voltage from the output terminals 31 in the fixing means 26 of the EL light-emitting device 20 can be fed at the same time to all the EL light-emitting sheets 1a even in a state in which the plural EL light-emitting sheets 1a including the non-light emitting sheet 21 are nipped in the EL light-emitting device 20.

As has been described above, the EL light-emitting device 20 of this example provides the following effects.

Light can be easily emitted only by sandwiching the EL light-emitting sheets 1a, and power can be fed by a driving device of one EL light-emitting device 20 to numerous EL light-emitting sheets 1a grouped together like a book, note, or catalog to emit light in any pattern for each of them, so that a high visual effect is obtained. Particularly, coexistence of the EL light-emitting sheets 1a and the non-light emitting sheet 21 brings about much information and a high visual effect.

Since the EL light-emitting sheets 1a can be repeatedly replaced, users', demands and change of them can be easily accommodated, and the replacement operation is easy to anyone.

The EL light-emitting sheets 1a, which have through-holes provided in electrode units in a sheet structure as normal EL and have conductive materials printed on both sides, are very simple. Inexpensive carbon and the like can be used without being processed. Wiring and soldering operations of lead wires, connectors, and the like are unnecessary to attach the EL light-emitting sheets 1a to the EL light-emitting device 20. On the other hand, the EL light-emitting device 20 is simple in construction and is easy to manufacture.

What is claimed is:

1. An EL light-emitting sheet formed by sealing a sheet-shaped EL light-emitting element with a substrate, a back electrode, an insulating layer, a light-emitting layer, and a transparent electrode stacked in this order, wherein an adhesive layer is formed in an outer side of the transparent electrode, and the EL light-emitting sheet can be stuck by the adhesive layer at a desired position of the back of a sheet-shaped exhibit having a light-transmitting capability at least partially.

2. The EL light-emitting sheet according to claim 1, wherein an opening is formed in the adhesive layer along a light-emitting pattern of the transparent electrode.

3. An EL light-emitting sheet formed by sealing a sheet-shaped EL light-emitting element with a substrate, a back electrode, an insulating layer, a light-emitting layer, and a transparent electrode stacked in this order, wherein a through-hole is formed in the EL light-emitting sheet, and the electrode of the EL light-emitting element is electrically connected through the through-hole to an input terminal provided at each of corresponding positions of both sides of the EL light-emitting sheet.

4. An EL light-emitting device which holds and drives an EL light-emitting sheet formed by sealing a sheet-shaped EL light-emitting element with a substrate, a back electrode, an insulating layer, a light-emitting layer, and a transparent electrode stacked in this order in which a through-hole is formed, and the electrode of the EL light-emitting element is electrically connected through the through-hole to an input terminal provided at each of corresponding positions of both sides of the EL light-emitting sheet, wherein the EL light-emitting device includes a driving circuit, an output terminal connected to the driving circuit, and releasable fixing means for pressing and fixing the EL light-emitting sheet stacked on the output terminal to bring the input terminal of the EL light-emitting sheet into contact with the output terminal.

5. The EL light-emitting device according to claim 4,
wherein a through-hole is formed in a sheet body, and a non-light emitting sheet formed by electrically connecting electrodes provided respectively at corresponding positions of both sides of the sheet body through the through-hole is stacked on the EL light-emitting sheet and fixed by the fixing means to bring the electrode of the non-light emitting sheet, the input terminal of the EL light-emitting sheet, and the output terminal into electrical connection.
